(19) United States
(12) Patent Application Publication
(10) Pub. No.: US 2018/0123159 A1
(43) Pub. Date: May 3, 2018

(54) RECHARGEABLE BATTERY AND RECHARGEABLE BATTERY MODULE

(71) Applicant: Samsung SDI Co., Ltd., Yongin-si (KR)

(72) Inventor: Dukjung KIM, Yongin-si (KR)

(21) Appl. No.: 15/782,624

(22) Filed: Oct. 12, 2017

(30) Foreign Application Priority Data
Nov. 2, 2016 (KR) 10-2016-0145079

(51) Int. Cl. H01M 10/04; H01M 2/10; H01M 10/613; H01M 10/6556

(52) U.S. Cl. CPC H01M 10/045; H01M 10/6556; H01M 10/613; H01M 2/1077

(57) ABSTRACT

A rechargeable battery includes: a case configured to receive an electrode assembly in a space between a first opening and a second opening at opposite sides thereof, the case including a cooling passage integrally provided at an outside thereof and configured to allow a coolant to flow therethrough; a bottom plate configured to close and seal the first opening of the case; a cap plate configured to be combined to the case at the second opening; and an electrode terminal at the cap plate and electrically connected to the electrode assembly.

### CROSS-REFERENCE TO RELATED APPLICATION

This application claims priority to and the benefit of Korean Patent Application No. 10-2016-0145079, filed in the Korean Intellectual Property Office on Nov. 2, 2016, the entire content of which is incorporated herein by reference.

### BACKGROUND

1. Field

Aspects of embodiments of the present disclosure relate to cooling a rechargeable battery.

2. Description of the Related Art

A rechargeable battery differs from a primary battery in that it is designed to be repeatedly charged and discharged, while the latter is not designed to be recharged. Low-capacity rechargeable batteries are used in small portable electronic devices, such as mobile phones, notebook computers, and camcorders, while high-capacity rechargeable batteries can be used as a power source for, as some examples, driving motors of a hybrid vehicle, an electric vehicle, and the like.

A rechargeable battery typically includes an electrode assembly for performing charging and discharging, a case for receiving the electrode assembly and an electrolyte solution, a cap plate combined with the case at an opening thereof, and an electrode terminal provided in the cap plate and electrically connected to the electrode assembly.

A rechargeable battery used in a vehicle may employ cooling or thermal management during a usage period thereof for securing performance and safety. To improve thermal management efficiency, effectively transmitting heat energy generated in a heat exchanger to the rechargeable battery and/or vice versa is desirable.

A liquid-cooled structure to ensure thermal performance of a rechargeable battery generally includes a heat transfer plate for passing coolant supplied from the heat exchanger of the vehicle to a heat transfer sheet that is combined with the heat transfer plate and allows for heat transfer between the rechargeable batteries and the heat exchanger.

However, heat transfer between the rechargeable battery and other parts or components using the contact manner (e.g., in direct contact or conduction) may not be constant due to variances in the parts or components, such as the heat transfer plate, the heat transfer sheet, and the like, and/or due to assembly variation of the parts or components and may not satisfy a target performance. Accordingly, performance degradation and safety deterioration of the rechargeable battery may occur.

The above information disclosed in this section is only for enhancement of understanding of the background of the present invention, and therefore, it may contain information that does not form prior art.

### SUMMARY

Aspects of the present disclosure provide a rechargeable battery that may be directly cooled without using a transfer medium, such as a heat transfer plate or a heat transfer sheet, to improve the cooling performance thereof. In addition, the present disclosure has been made in an effort to provide a rechargeable battery module to which the aforementioned rechargeable battery may be applied.

An exemplary embodiment of the present invention provides a rechargeable battery including: a case configured to receive an electrode assembly in a space between a first opening and a second opening at opposite sides thereof, the case including a cooling passage integrally provided at an outside thereof and configured to allow a coolant to flow therethrough; a bottom plate configured to close and seal the first opening of the case; a cap plate configured to be combined to the case at the second opening; and an electrode terminal at the cap plate and electrically connected to the electrode assembly.

The case may further include: a pair of first sides corresponding to a length of the cap plate and facing each other in a width direction of the cap plate; and a pair of second sides corresponding to a width of the cap plate at opposite ends of the first side and facing each other in a length direction of the cap plate. The first sides may be wider than the second sides.

The cooling passage may be at an outer surface of each of the second sides to directly cool the second sides.

The cooling passage may extend in a direction crossing extension surfaces of the cap plate and the bottom plate.

The case may be continuously processed by using an extrusion process and may be cut at a length between the first opening and the second opening.

The cooling passage may be formed by welding a semi-quadrangular or semi-circular member having one side in a width direction and opposite ends in a length direction of the case open to an outer side of the case.

Another exemplary embodiment of the present invention provides a rechargeable battery module including: a plurality of unit cells, each of the unit cells including: a case having a first opening and a second opening at opposite sides thereof and for receiving an electrode assembly, the first opening and the second opening being respectively closed and sealed with a bottom plate and a cap plate; an electrode terminal at the cap plate and electrically connected to the electrode assembly; and a cooling passage integrally provided at an outside of the case and configured to allow coolant to flow therethrough; bus bars configured to electrically connect the electrode terminals of the unit cells; and a coolant pipe configured to connect the cooling passages to each other to circulate the coolant.

The case may include: a pair of first sides corresponding to a length of the cap plate and facing each other in a width direction of the cap plate; and a pair of second sides corresponding to a width of the cap plate at opposite ends of the first sides and facing each other in a length direction of the cap plate. The first sides may be wider than the second sides, and the unit cells may face each other based on the first sides thereof.

The second sides of the unit cells may be at upper and lower ends of the rechargeable battery module, and the first sides of the unit cells may be at lateral sides of the rechargeable battery module.

The cooling passage may extend in a direction crossing extension surfaces of the cap plate and the bottom plate and may be at an outer surface of the second side. The coolant pipe may extend in a horizontal direction crossing the extending direction of the cooling passage to connect the cooling passages of the unit cells to each other.

The first sides of the unit cells may be at upper and lower sides of the rechargeable battery module, and the second sides of the unit cells may be at lateral sides of the rechargeable battery module.

The cooling passage may extend in a direction crossing extension surfaces of the cap plate and the bottom plate and may be at an outer surface of the second side. The coolant pipe may be arranged in a vertical direction crossing the extending direction of the cooling passage to connect the cooling passages of the unit cells to each other.

According to embodiments of the present invention, because the cooling passage is integrated with the outside of the case and is configured for a coolant to flow therethrough, it is possible to directly cool the case with the coolant without separately using the transfer medium (e.g., the heat transfer plate and the heat transfer sheet). Accordingly, the cooling performance of the rechargeable battery and the rechargeable battery module may be improved.

In addition, because the heat transfer medium is omitted from the rechargeable battery and the rechargeable battery module, the parts or components for cooling and the assembling variation of the parts may be reduced or eliminated. Accordingly, the target cooling performance may be more easily secured. That is, the performance and safety of the rechargeable battery may be improved.

### BRIEF DESCRIPTION OF THE DRAWINGS

FIG. 1 illustrates a perspective view of a rechargeable battery according to a first exemplary embodiment of the present invention.

FIG. 2 illustrates a cross-sectional view taken along the line II-II of FIG. 1.

FIG. 3 illustrates a partial exploded perspective view of a rechargeable battery according to a second exemplary embodiment of the present invention.

FIG. 4 illustrates a partial top plan view of a rechargeable battery according to a third exemplary embodiment of the present invention.

FIG. 5 illustrates a perspective view of a rechargeable battery module according to a fourth exemplary embodiment of the present invention.

FIG. 6 illustrates a front view of the rechargeable battery module shown in FIG. 5.

FIG. 7 illustrates a front view of a rechargeable battery module according to a fifth exemplary embodiment of the present invention.

### DETAILED DESCRIPTION

The present invention will be described more fully hereinafter with reference to the accompanying drawings, in which exemplary embodiments of the present invention are shown. As those skilled in the art would realize and understand, the described exemplary embodiments may be modified in various different ways, all without departing from the spirit or scope of the present invention. The drawings and description are to be regarded as illustrative in nature and not restrictive, and like reference numerals designate like elements throughout the specification.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements. As used herein, the term “and/or” includes any and all combinations of one or more of the associated listed items. Further, the use of “may” when describing embodiments of the present invention relates to “one or more embodiments of the present invention.” Also, the term “exemplary” is intended to refer to an example or illustration.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments. In the figures, dimensions of the various elements, layers, etc. may be exaggerated for clarity of illustration.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing particular example embodiments of the present invention and is not intended to be limiting of the described example embodiments of the present invention. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

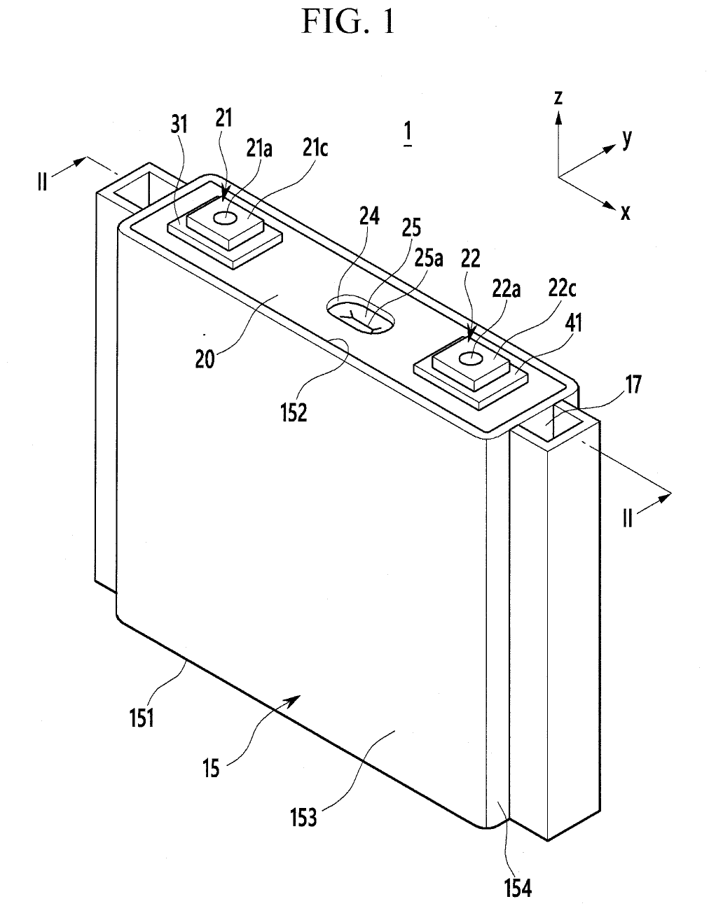

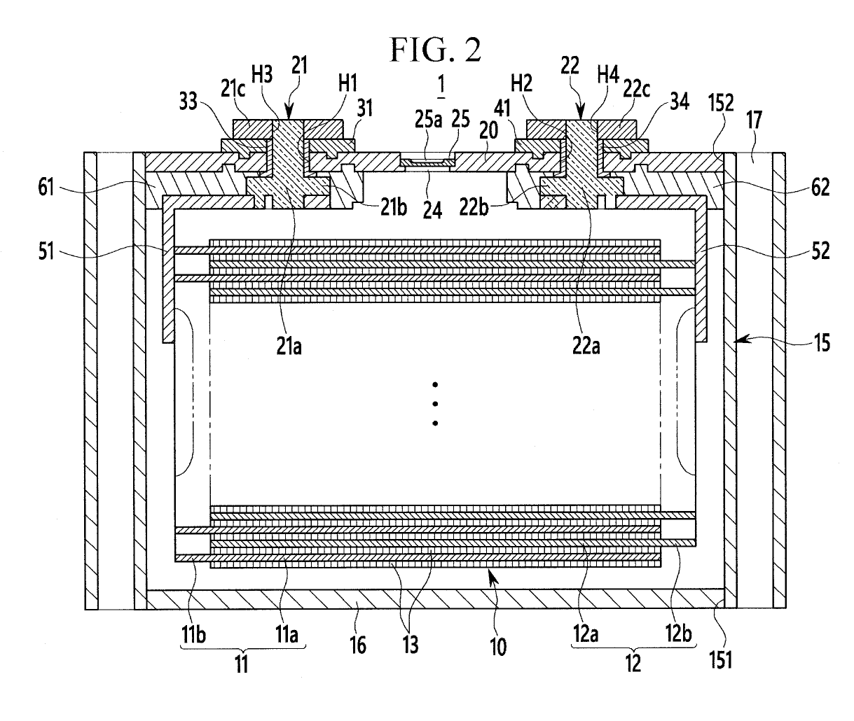

FIG. 1 illustrates a perspective view of a rechargeable battery according to a first exemplary embodiment of the present invention, and FIG. 2 illustrates a cross-sectional view taken along the line II-II of FIG. 1. Referring to FIGS. 1 and 2, a rechargeable battery 1 according to a first exemplary embodiment includes an electrode assembly 10 for charging or discharging a current, a case 15 for receiving the electrode assembly 10 and an electrolyte solution, a bottom plate 16 for closing and sealing a first opening 151 of the case 15, a cap plate 20 combined with (e.g., for sealing and closing) a second opening 152 of the case 15, and electrode terminals 21 and 22 provided at (e.g., extending through) the cap plate 20.

For example, in the electrode assembly 10, electrodes (e.g., a negative electrode 11 and a positive electrode 12) are disposed at opposite sides of a separator 13 (e.g., an insulator), and the negative electrode 11, the separator 13, and the positive electrode 12 are spirally wound in a jelly-roll state. In another embodiment, the negative electrode, the separator, and the positive electrode of the electrode assembly may be stacked.

The negative and positive electrodes 11 and 12 respectively include coated regions 11a and 12a, where an active material is coated on current collectors made of a metal plate, and uncoated regions 11b and 12b, where an active material is not coated on the current collectors and which are exposed portions of the current collectors.

The uncoated region 11b of the negative electrode 11 is provided at one end portion of the negative electrode 11 along the wound negative electrode 11 (e.g., at one edge of the electrode assembly 10). The uncoated region 12b of the positive electrode 12 is provided at another end portion of the positive electrode 12 along the wound positive electrode 12 (e.g., at another edge of the electrode assembly 10). For example, the uncoated regions 11b and 12b are respectively disposed at opposite end portions of the electrode assembly 10.

The case 15 is substantially formed as a cuboid so that the electrode assembly 10 may be received in a main inner space thereof. The case 15 receives the electrode assembly 10 in a main space thereof extending between the first opening 151 and the second opening 152, which face each other along a length direction (e.g., a z-axis direction).

Because the first and second openings 151 and 152 of the case 15 are provided at opposite sides of the cuboid, the case 15 may be extrusion-molded. For example, the case 15 may be formed by cutting a member extruded by an extrusion molding process to have a length extending between the first and second openings 151 and 152. By forming the case 15 by using the extrusion molding, a manufacturing cost of the case 15 may be reduced.

For example, the bottom plate 16 is combined and welded to the case 15 at the first opening 151 thereof to close and seal the first opening 151 that forms a lower portion of the case 15. Accordingly, the electrode assembly 10 may be inserted into the case 15 through the second opening 152.

The cap plate 20 is combined and welded to the case 15 at the second opening 152 thereof to close and seal the second opening 152 that forms an upper portion of the case 15. For example, the case 15 and the cap plate 20 may be made of aluminum and may be welded to each other. For example, after closing and sealing the first opening 151 of the case 15 and inserting the electrode assembly 10 into the case 15, the cap plate 20 is welded to the second opening 152 of the case 15.

The cap plate 20 includes openings, for example, terminal openings H1 and H2 (e.g., terminal holes) and a vent opening 24 (e.g., a vent hole). The electrode terminals 21 and 22 are respectively provided in (e.g., extend through) the terminal openings H1 and H2 of the cap plate 20 to be electrically connected to the electrode assembly 10.

For example, the electrode terminals 21 and 22 are electrically connected to the negative electrode 11 and the positive electrode 12 of the electrode assembly 10, respectively. Accordingly, the electrode assembly 10 may be drawn out of the case 15 through the electrode terminals 21 and 22.

The electrode terminals 21 and 22 respectively include plate terminals 21c and 22c disposed at the outside of the cap plate 20 corresponding to the terminal openings H1 and H2 and rivet terminals 21a and 22a electrically connected to the electrode assembly 10 and passing through the terminal opening H1 and H2 and fastened to the plate terminals 21c and 22c.

The plate terminals 21c and 22c respectively include openings H3 and H4 (e.g., through-holes). The rivet terminals 21a and 22a upwardly pass through the terminal openings H1 and H2 to be inserted into the openings H3 and H4. The electrode terminals 21 and 22 respectively include flanges 21b and 22b widely integrated with the rivet terminals 21a and 22a at an inner side of the cap plate 20.

At the electrode terminal 21 connected to the negative electrode 11, an outer insulating member 31 interposed between the plate terminal 21c and the cap plate 20 electrically insulates the plate terminal 21c from the cap plate 20. For example, the cap plate 20 maintains a state of being electrically insulated from the negative electrode 11.

By combining the insulating member 31 and the plate terminal 21c to an upper end portion of the rivet terminal 21a and then riveting or welding the upper end portion of the rivet terminal 21a, the insulating member 31 and the plate terminal 21c are fastened to the upper end portion of the rivet terminal 21a. The plate terminal 21c is provided at the outside of the cap plate 20 with the insulating member 31 therebetween.

At the electrode terminal 22 connected to the positive electrode 12, a conductive top plate 41 is interposed between the plate terminal 22c and the cap plate 20 to electrically connect the plate terminal 22c and the cap plate 20. That is, the cap plate 20 maintains a state of being electrically connected to the electrode assembly 10 and the positive electrode 12.

By combining the top plate 41 and the plate terminal 22c with an upper end portion of the rivet terminal 22a and then riveting or welding the upper end portion of the rivet terminal 22a, the top plate 41 and the plate terminal 22c are fastened to the upper end portion of the rivet terminal 22a. The plate terminal 22c is provided at the outside of the cap plate 20 with the top plate 41 therebetween.

Gaskets 33 and 34 are respectively provided between the rivet terminals 21a and 22a of the electrode terminals 21 and 22 and inner surfaces of the cap plate 20 at the terminal openings H1 and H2 thereof. The gaskets 33 and 34 seal the area between the rivet terminals 21a and 22a and the cap plate 20 and electrically insulate the rivet terminals 21a and 22a and the cap plate 20 from each other.

The gaskets 33 and 34 extend between the flanges 21b and 22b and an inner surface of the cap plate 20 to further seal between and electrically insulate the flanges 21b and 22b and the cap plate 20 from each other. For example, the gaskets 33 and 34 allow the electrode terminals 21 and 22 to be installed on the cap plate 20 while preventing the electrolyte from leaking through the terminal openings H1 and H2.

Respective lead tabs 51 and 52 respectively electrically connect the electrode terminals 21 and 22 to the negative and positive electrodes 11 and 12 of the electrode assembly 10. For example, by combining the lead tabs 51 and 52 with lower end portions of the rivet terminals 21a and 22a and then caulking the lower end portions, the lead tabs 51 and 52 are supported by the flanges 21b and 22b and are connected to the lower end portions of the rivet terminals 21a and 22a.

Insulating members 61 and 62 are respectively provided between the electrode lead tabs 51 and 52 and the cap plate 20 to electrically insulate therebetween. Further, the insulating members 61 and 62 are combined to the cap plate 20 at one side thereof and enclose the lead tabs 51 and 52, the rivet terminals 21a and 22a, and the flanges 21b and 22b at the other side thereof, thereby stabilizing a connecting structure between them.

The vent opening 24 is closed and sealed by a vent plate 25 so that an internal pressure and gas generated in the rechargeable battery 1 may be selectively discharged. For example, the vent plate 25 is configured to rupture to open the vent opening 24 when the internal pressure of the rechargeable battery 1 reaches a reference pressure. The vent plate 25 is provided with a notch 25a that induces the rupture at the reference pressure.

The case 15 includes a cooling passage 17 that is integrally provided at the outside thereof and allows a coolant to flow therethrough. For example, the case 15, which is formed as the cuboid, includes a pair of wide surfaces 153 (e.g., wide sides or first sides) facing each other and a pair of narrow surfaces 154 (e.g., narrow sides or second sides) facing each other.

The wide surfaces 153 are x-z surfaces or sides corresponding to a length of the cap plate 20 (e.g., a length in an x-axis direction), and the narrow surfaces 154 are y-z surfaces or sides corresponding to a width of the cap plate 20 (e.g., a length in a y-axis direction) at opposite ends of the wide surfaces 153 in the x-axis direction.

For example, the cooling passages 17 are provided at outer surfaces of the pair of narrow surfaces 154 to directly cool (e.g., to allow coolant to directly contact) the narrow surfaces 154 of the case 15. The cooling passages 17 are formed to extend in directions crossing extension surfaces (e.g., the x-y surfaces) of the cap plate 20 and the bottom plate 16.

Because the cooling passage 17 is integrally formed at the case 15 to allow coolant to directly flow along an outer surface of the case 15, separate transfer media (e.g., the heat transfer plate and the heat transfer sheet used in the related art) may be omitted. In addition, because the cooling passages 17 supply, flow, and discharge coolant in a z-axis direction at opposite sides of the case 15 in the x-axis direction, it is possible to cool the case 15 and the rechargeable battery 1.

Further, because the cooling passages 17 are provided at opposite sides of the case 15 such that the case 15 may be extruded and processed together with the cooling passages 17, the case 15 may be cut and formed to have a length between the first opening 151 and the second opening 152. Accordingly, the cooling passage 17 is integrally processed with the case 15 in one process (e.g., in a single process), thereby eliminating a separate manufacturing process thereafter.

Hereinafter, various other exemplary embodiments of the present invention will be described. Aspects and configurations of the first exemplary embodiment that are the same or substantially the same as that of the other exemplary embodiments may be omitted, and different configurations therebetween will be primarily described.

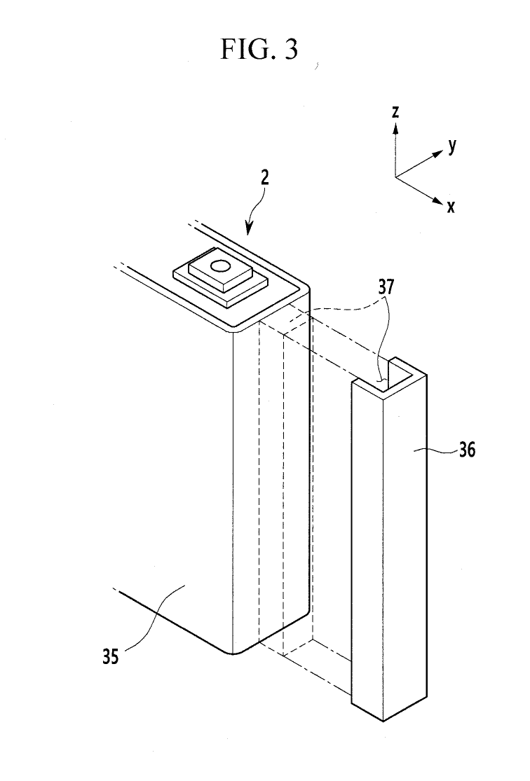

FIG. 3 illustrates a partial exploded perspective view of a rechargeable battery according to a second exemplary embodiment of the present invention. Referring to FIG. 3, in a rechargeable battery 2 according to the second exemplary embodiment, a cooling passage 37 is formed by welding a semi-quadrangular member 36, of which one side in a width direction (e.g., in an x-axis direction) and opposite ends in a length direction (e.g., in a z-axis direction) are opened to an outer surface or outer side of a case 35 and form a main space thereof.

The cooling passage 37 allows coolant to directly flow along an outer surface of the case 35, thereby allowing a separate transfer medium to be omitted. In addition, because the cooling passage 37 supplies, flows, and discharges coolant in the z-axis direction from opposite sides of the case 35 in the x-axis direction, it is possible to cool the case 35 and the rechargeable battery 2.

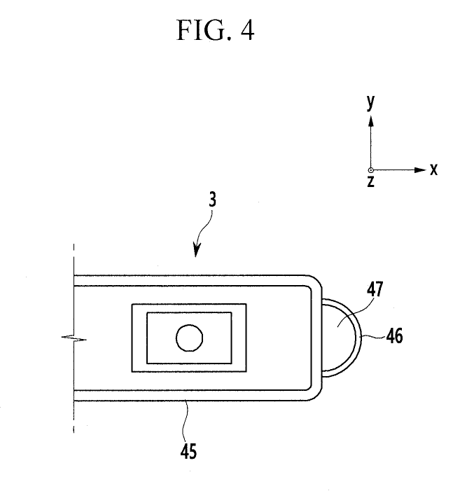

FIG. 4 illustrates a partial top plan view of a rechargeable battery according to a third exemplary embodiment of the present invention. Referring to FIG. 4, in a rechargeable battery 3 according to the third exemplary embodiment, a cooling passage 47 is formed by welding a semi-circular member 46, of which one side in a width direction and opposite ends in a length direction open to an outer side of a case 45 and form a main space thereof.

The cooling passage 47 allows coolant to directly flow along an outer surface of the case 45, thereby allowing a separate transfer medium to be omitted. In addition, because the cooling passage 47 supplies, flows, and discharges coolant in the z-axis direction from opposite sides of the case 45 of the x-axis direction, it is possible to cool the case 45 and the rechargeable battery 3.

Hereinafter, rechargeable battery modules 100 and 200 in which the rechargeable battery 1 according to the first exemplary embodiment is applied as a unit cell 1 will be described.

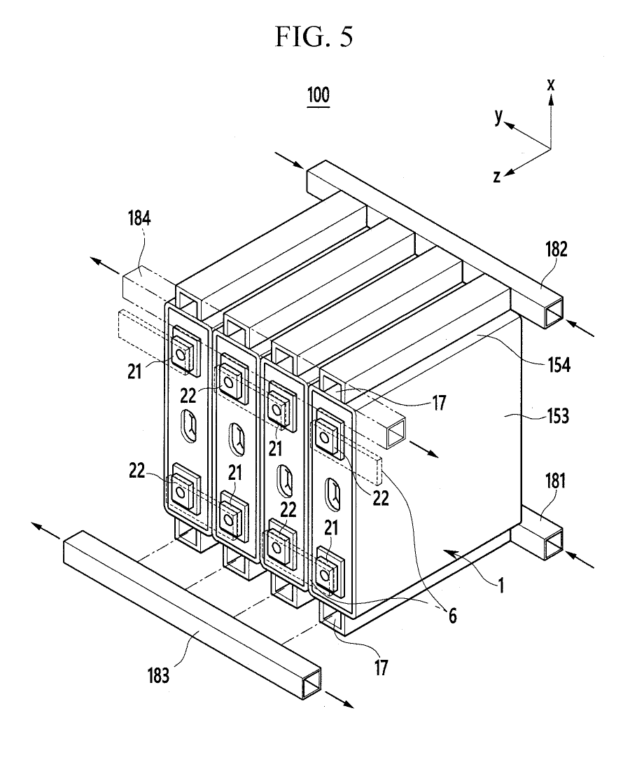

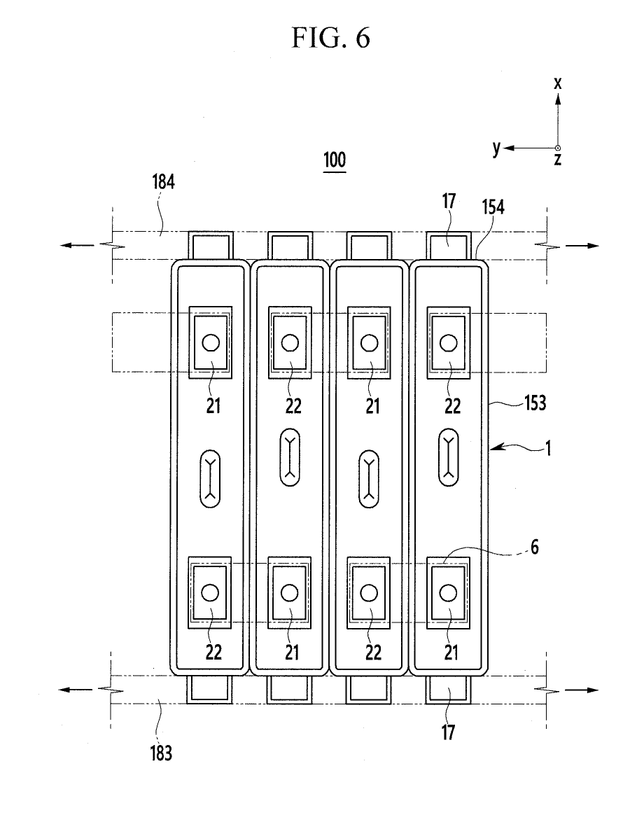

FIG. 5 is a perspective view of a rechargeable battery module according to a fourth exemplary embodiment of the present invention, and FIG. 6 is a front view of FIG. 5. Referring to FIGS. 5 and 6, a rechargeable battery module 100 according to the fourth exemplary embodiment includes bus bars 6 for electrically connecting the electrode terminals 21 and 22 of unit cells 1 and a coolant pipe for circulating coolant by connecting the cooling passages 17 of the unit cells 1 to each other.

The unit cells 1 are disposed to face each other based on the wide surfaces 153. For example, the unit cells 1 are disposed to be adjacent to each other (or arranged in) in a y-axis direction while facing each other based on an x-z surface. The narrow surfaces 154 of the unit cells 1 are arranged at upper and lower sides of the rechargeable battery module 100 (e.g., at upper and lower sides in an x-axis direction), and the wide surfaces 153 of the unit cells 1 are arranged at lateral sides thereof (e.g., at opposite sides in the y-axis direction).

In this case, the rechargeable battery module 100 has a height (e.g., a height in an x-direction) corresponding to a length direction (e.g., the x-axis direction) of the cap plate 20 of the unit cell 1, and the rechargeable battery module 100 may be installed in a rechargeable battery pack, an electric vehicle, or the like. As the number of the unit cells 1 disposed in (or aligned or arranged in) the y-axis direction increases, capacity of the rechargeable battery module 100 may increase.

The coolant pipe is disposed in (or extends in) a horizontal direction (e.g., the y-axis direction) crossing an extension surface (e.g., an x-z surface) of the wide surfaces 153 of the unit cells 1 to connect the cooling passages 17 of the unit cells 1 to each other. For example, the coolant pipe includes first and second supplying pipes 181 and 182 for supplying coolant (e.g., for supplying low-temperature coolant) and first and second discharging pipes 183 and 184 for discharging the coolant (e.g., for discharging high-temperature coolant).

For example, the first and second supplying pipes 181 and 182 supply coolant to one end of the cooling passages 17. The coolant passing through the cooling passages 17 flows to the first and second discharging pipes 183 and 184 and is then discharged through respective end portions of the first and second discharging pipes 183 and 184. Accordingly, a circulating path of the coolant may be shortened to be about half of a distance of the rechargeable battery module 100 in the y-axis direction as coolant flows into the first and second supplying pipes 181 and 182 via both ends thereof and flows out of the first and second discharging pipes 183 and 184 via both ends thereof. As such, the cooling efficiency of the unit cells 1 may be improved.

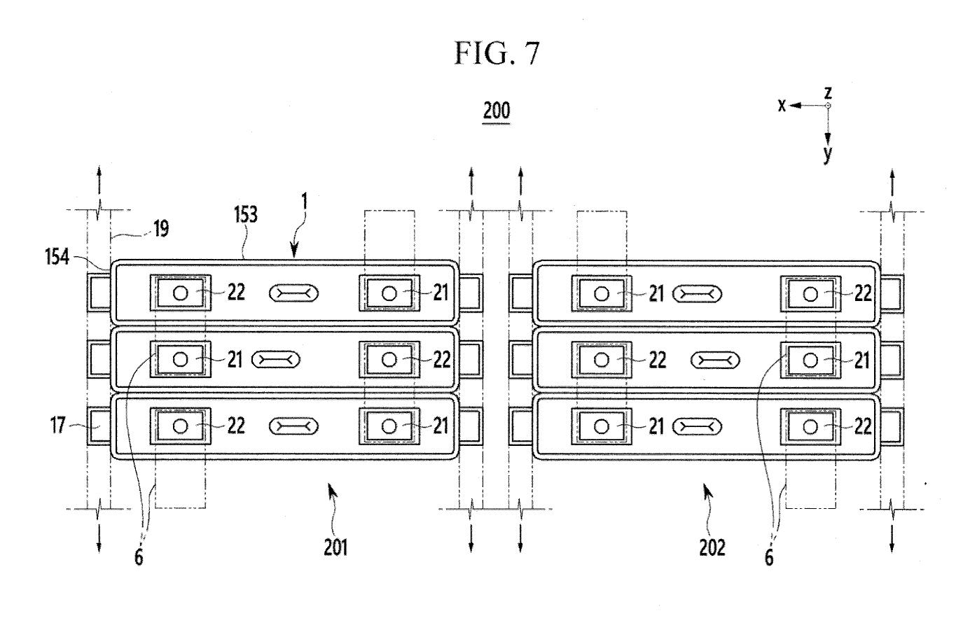

FIG. 7 illustrates a front view of a rechargeable battery according to a fifth exemplary embodiment of the present invention. Referring to FIG. 7, a rechargeable battery module 200 according to the fifth exemplary embodiment is formed by electrically connecting the electrode terminals 21 and 22 of the unit cells 1 with the bus bars 6.

The wide surfaces 153 of the unit cells 1 are disposed at upper and lower sides of the rechargeable battery module 200 (e.g., at upper and lower sides in a y-axis direction), and the narrow surfaces 154 of the unit cells 1 are disposed at lateral sides of the rechargeable battery module 200 (e.g., at opposite sides in a x-axis direction). For example, the unit cells 1 are disposed to be adjacent to each other in the y-axis direction while x-z surfaces of adjacent ones of the unit cells 1 face each other.

The coolant pipe 19 is disposed in (or extends in) a vertical direction (e.g., in the y-axis direction) crossing an extension surface (e.g., the x-z surface) of the wide surfaces 153 of the unit cells 1 to connect the cooling passages 17 of the unit cells 1 that are vertically disposed or arranged.

In the rechargeable battery module 200 according to the fifth exemplary embodiment, a first group 201 (e.g., a first group of the unit cells 1) is formed by electrically connecting three of the unit cells 1 together, and a second group 202 (e.g., a second group of the unit cells 1) is formed by electrically connecting three other ones of the unit cells 1 together at one side of the first group 201 in an x-axis direction.

The first and second groups 201 and 202 are connected with a bus bar 26 to form the rechargeable battery module 200. For example, the first and second groups 201 and 202 may reduce a height of the rechargeable battery module 200 (e.g., in a y-axis direction of FIG. 7). Accordingly, the rechargeable battery module 200 may be effectively installed in a vehicle in which a wide space with a low height is provided.

While the present invention has been described in connection with what is presently considered to be practical exemplary embodiments, it is to be understood that the present invention is not limited to the disclosed embodiments. The present invention is intended to cover various modifications and equivalent arrangements included within the spirit and scope of the appended claims and their equivalents.

<Description of Some Reference Symbols>

| | |
|---|---|
| 1, 2, 3: rechargeable battery (unit cell) | 6, 26: bus bar |
| 10: electrode assembly | 11: negative electrode |
| 11a, 12a: coated region | 11b, 12b: uncoated region |
| 12: positive electrode | 13: separator |
| 15, 35, 45: case | 16: bottom plate |
| 17, 37, 47: cooling passage | 18, 19: coolant pipe |
| 20: cap plate | 21, 22: electrode terminal |
| 21a, 22a: rivet terminal | 21b, 22b: flange |
| 21c, 22c: plate terminal | 24: vent opening (e.g., |
| | vent hole) |
| 25: vent plate | 25a: notch |
| 31: insulating member | 33, 34: gasket |
| 36: semi-quadrangular member | 41: top plate |
| 46: semi-circular member | 51, 52: lead tab |

61, 62: insulating member
100, 200: rechargeable battery module

| | |
|---|---|
| 151: first opening | 152: second opening |

153: wide surface (e.g., wide/first side)
154: narrow surface (e.g., narrow/second side)

| | |
|---|---|
| 181, 182: first, second supplying pipe | 183, 184: first, second |
| | discharging pipe |

143478

| | |
|---|---|
| 201: first group | 202: second group |
| H1, H2: terminal opening (e.g., terminal | H3, H4: opening (e.g., |
| hole) | through-hole) |

What is claimed is:

1. A rechargeable battery comprising:
a case configured to receive an electrode assembly in a space between a first opening and a second opening at opposite sides thereof, the case comprising a cooling passage integrally provided at an outside thereof and configured to allow a coolant to flow therethrough;
a bottom plate configured to close and seal the first opening of the case;
a cap plate configured to be combined to the case at the second opening; and
an electrode terminal at the cap plate and electrically connected to the electrode assembly.

2. The rechargeable battery of claim 1, wherein the case further comprises:
a pair of first sides corresponding to a length of the cap plate and facing each other in a width direction of the cap plate; and
a pair of second sides corresponding to a width of the cap plate at opposite ends of the first sides and facing each other in a length direction of the cap plate, the first sides being wider than the second sides.

3. The rechargeable battery of claim 2, wherein the cooling passage is at an outer surface of each of the second sides to directly cool the second sides.

4. The rechargeable battery of claim 3, wherein the cooling passage extends in a direction crossing extension surfaces of the cap plate and the bottom plate.

5. The rechargeable battery of claim 1, wherein the case is continuously processed by using an extrusion process and is cut at a length between the first opening and the second opening.

6. The rechargeable battery of claim 1, wherein the cooling passage is formed by welding a semi-quadrangular or semi-circular member having one side in a width direction and opposite ends in a length direction of the case open to an outer side of the case.

7. A rechargeable battery module comprising:
a plurality of unit cells, each of the unit cells comprising:
a case having a first opening and a second opening at opposite sides thereof and for receiving an electrode assembly, the first opening and the second opening being respectively closed and sealed with a bottom plate and a cap plate;
an electrode terminal at the cap plate and electrically connected to the electrode assembly; and
a cooling passage integrally provided at an outside of the case and configured to allow coolant to flow therethrough;
bus bars configured to electrically connect the electrode terminals of the unit cells; and
a coolant pipe configured to connect the cooling passages to each other to circulate the coolant.

8. The rechargeable battery module of claim 7, wherein the case comprises:
a pair of first sides corresponding to a length of the cap plate and facing each other in a width direction of the cap plate; and
a pair of second sides corresponding to a width of the cap plate at opposite ends of the first side and facing each other in a length direction of the cap plate, the first sides being wider than the second sides, and
wherein the unit cells face each other based on the first sides thereof.

9. The rechargeable battery module of claim 8, wherein the second sides of the unit cells are at upper and lower ends of the rechargeable battery module, and the first sides of the unit cells are at lateral sides of the rechargeable battery module.

10. The rechargeable battery module of claim 9, wherein the cooling passage extends in a direction crossing extension surfaces of the cap plate and the bottom plate and is at an outer surface of the second side, and
wherein the coolant pipe extends in a horizontal direction crossing the extending direction of the cooling passage to connect the cooling passages of the unit cells to each other.

11. The rechargeable battery module of claim 8, wherein the first sides of the unit cells are at upper and lower sides of the rechargeable battery module, and the second sides of the unit cells are at lateral sides of the rechargeable battery module.

12. The rechargeable battery module of claim 11, wherein the cooling passage extends in a direction crossing extension surfaces of the cap plate and the bottom plate and is at an outer surface of the second side, and
wherein the coolant pipe is arranged in a vertical direction crossing the extending direction of the cooling passage to connect the cooling passages of the unit cells to each other.
